(19) United States
(12) Patent Application Publication
(10) Pub. No.: US 2025/0380255 A1
(43) Pub. Date: Dec. 11, 2025

(54) SELF-SCHEDULED UPLINK TRANSMISSIONS USING RESOURCE POOLS ASSOCIATED WITH TIMING ADVANCE ACCURACIES

(71) Applicant: QUALCOMM Incorporated, San Diego, CA (US)

(72) Inventors: Raviteja PATCHAVA, San Diego, CA (US); Jing SUN, San Diego, CA (US); Junyi LI, Greentown, PA (US); Xiaoxia ZHANG, San Diego, CA (US); Jing JIANG, San Diego, CA (US)

(21) Appl. No.: 18/738,922

(22) Filed: Jun. 10, 2024

(51) Int. Cl. H04W 72/1268; H04B 7/0452; H04L 1/00; H04L 5/00; H04W 56/00; H04W 72/02

(52) U.S. Cl. CPC H04W 72/1268; H04B 7/0452; H04L 1/0003; H04L 5/0051; H04W 56/0045; H04W 72/02

(57) ABSTRACT

Various aspects of the present disclosure generally relate to wireless communication. In some aspects, a user equipment (UE) may receive a configuration that indicates a plurality of resource pools. The UE may select a resource pool from the plurality of resource pools based at least in part on a timing advance (TA) accuracy associated with the UE. The UE may transmit, via a resource in the resource pool, an uplink transmission in accordance with a UE uplink self-scheduling. Numerous other aspects are described.

### INTRODUCTION

Aspects of the present disclosure generally relate to wireless communication and specifically relate to techniques, apparatuses, and methods for self-scheduled uplink transmissions.

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to an apparatus for wireless communication at a user equipment (UE). The apparatus may include one or more memories and one or more processors coupled to the one or more memories. The one or more processors may be configured to cause the UE to receive a configuration that indicates a plurality of resource pools. The one or more processors may be configured to cause the UE to select a resource pool from the plurality of resource pools based at least in part on a timing advance (TA) accuracy associated with the UE. The one or more processors may be configured to cause the UE to transmit, via a resource in the resource pool, an uplink transmission in accordance with a UE uplink self-scheduling.

Some aspects described herein relate to an apparatus for wireless communication at a network node. The apparatus may include one or more memories and one or more processors coupled to the one or more memories. The one or more processors may be configured to cause the network node to output a configuration that indicates a plurality of resource pools. The one or more processors may be configured to cause the network node to obtain, via a resource in a resource pool of the plurality of resource pools, an uplink transmission, wherein the resource pool is associated with a TA accuracy of a UE.

Some aspects described herein relate to a method of wireless communication performed at a UE. The method may include receiving a configuration that indicates a plurality of resource pools. The method may include selecting a resource pool from the plurality of resource pools based at least in part on a TA accuracy associated with the UE. The method may include transmitting, via a resource in the resource pool, an uplink transmission in accordance with a UE uplink self-scheduling.

Some aspects described herein relate to a method of wireless communication performed at a network node. The method may include transmitting a configuration that indicates a plurality of resource pools. The method may include receiving, via a resource in a resource pool of the plurality of resource pools, an uplink transmission, wherein the resource pool is associated with a TA accuracy of a UE.

Some aspects described herein relate to a non-transitory computer-readable medium that stores a set of instructions for wireless communication by a UE. The set of instructions, when executed by one or more processors of the UE, may cause the UE to receive a configuration that indicates a plurality of resource pools. The set of instructions, when executed by one or more processors of the UE, may cause the UE to select a resource pool from the plurality of resource pools based at least in part on a TA accuracy associated with the UE. The set of instructions, when executed by one or more processors of the UE, may cause the UE to transmit, via a resource in the resource pool, an uplink transmission in accordance with a UE uplink self-scheduling.

Some aspects described herein relate to a non-transitory computer-readable medium that stores a set of instructions for wireless communication by a network node. The set of instructions, when executed by one or more processors of the network node, may cause the network node to transmit a configuration that indicates a plurality of resource pools. The set of instructions, when executed by one or more processors of the network node, may cause the network node to receive, via a resource in a resource pool of the plurality of resource pools, an uplink transmission, wherein the resource pool is associated with a TA accuracy of a UE.

Some aspects described herein relate to an apparatus for wireless communication. The apparatus may include means for receiving a configuration that indicates a plurality of resource pools. The apparatus may include means for selecting a resource pool from the plurality of resource pools based at least in part on a TA accuracy associated with the apparatus. The apparatus may include means for transmitting, via a resource in the resource pool, an uplink transmission in accordance with a UE uplink self-scheduling.

Some aspects described herein relate to an apparatus for wireless communication. The apparatus may include means for transmitting a configuration that indicates a plurality of resource pools. The apparatus may include means for receiving, via a resource in a resource pool of the plurality of resource pools, an uplink transmission, wherein the resource pool is associated with a TA accuracy of a UE.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network, in accordance with the present disclosure.

FIG. 2 is a diagram illustrating an example network node in communication with a user equipment (UE) in a wireless network, in accordance with the present disclosure.

FIG. 3 is a diagram illustrating an example disaggregated base station architecture, in accordance with the present disclosure.

FIGS. 4-5 are diagrams illustrating examples associated with self-scheduled uplink transmissions using resource pools associated with timing advance (TA) accuracies, in accordance with the present disclosure.

FIG. 6 is a flowchart illustrating an example process performed, for example, by a UE, in accordance with the present disclosure.

FIG. 7 is a flowchart illustrating an example process performed, for example, by a network node, in accordance with the present disclosure.

FIG. 8 is a diagram of an example apparatus for wireless communication, in accordance with the present disclosure.

FIG. 9 is a diagram illustrating an example of a hardware implementation for an apparatus employing a processing system, in accordance with the present disclosure.

FIG. 10 is a diagram illustrating an example of an implementation of code and circuitry for an apparatus, in accordance with the present disclosure.

FIG. 11 is a diagram of an example apparatus for wireless communication, in accordance with the present disclosure.

FIG. 12 is a diagram illustrating an example of a hardware implementation for an apparatus employing a processing system, in accordance with the present disclosure.

FIG. 13 is a diagram illustrating an example of an implementation of code and circuitry for an apparatus, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A network node may schedule an uplink transmission for a user equipment (UE) in accordance with a per-UE uplink scheduling. The network node may transmit, to the UE, signaling to indicate an allocated resource. The allocated resource may be a time-frequency domain resource. The UE may perform the uplink transmission using the allocated resource. The UE may transmit the uplink transmission via the allocated resource. When the uplink transmission is associated with a relatively small data payload (e.g., a size of the uplink transmission is less than a threshold), a signaling overhead to indicate the allocated resource may be larger the uplink transmission itself.

An uplink transmission that is associated with a UE self-scheduling may reduce a network signaling overhead, in relation to the uplink transmission configured using the per-UE uplink scheduling. In this example, the network node may provide a configuration of a resource pool for the uplink transmission. The resource pool may include a plurality of resources that are available for the UE to use for the uplink transmission. In one example, the resources may be time-frequency domain resources. When the UE has uplink data to transmit, the UE may randomly or non-randomly select a resource from the resource pool, and the UE may use that resource to perform the uplink transmission. The UE may perform the uplink transmission via the resource selected from the resource pool. With UE self-scheduling, the UE may not wait for an uplink grant from the network node. Rather, the UE may transmit in a randomly selected resource in the resource pool. In one example, the network node may not allow full flexibility for the UE to schedule the uplink transmission itself, but rather the network node may provide a configuration and the resource pool to allow the UE to self-schedule its uplink transmission. The resource pool may be shared by a plurality of UEs. In other words, each of the UEs in the plurality of UEs may select a resource from the resource pool in order to perform self-scheduled uplink transmissions.

During an initial access, the UE may perform a random access procedure with the network node. The UE may request access to a network via the random access procedure. During the random access procedure, the UE may acquire a timing advance (TA) from the network node. The TA may be a command or notification from the network node that enables the UE to adjust its uplink transmission to the network node. The TA may be used to control an uplink transmission timing of the UE, which may ensure that uplink transmissions received from the plurality of UEs are synchronized when received by the network node. Depending on each UE's location, relative to the network node, the UE may apply a different TA, such that the plurality of uplink transmissions received from the plurality of UEs are synchronized when received by the network node. For example, when the UE is relatively close to the network node and has a shorter propagation delay, the TA may be relatively small, whereas when the UE is relatively far from the network node and has a longer propagation delay, the TA may be relatively large. A distance between the UE and the network node may satisfy a first threshold when the UE is relatively close to the network node. A distance between the UE and the network node may satisfy a second threshold when the UE is relatively far away from the network node.

When an uplink traffic of the UE is relatively sparse (e.g., the UE has infrequent uplink transmissions, where an infrequent uplink transmission may be an uplink transmission that occurs with a frequency that satisfies a threshold), the TA acquired during the random access procedure may become inaccurate after a period of time, due to a mobility of the UE. For example, when the UE moves from a first location to a second location but does not reperform the random access procedure, the previously acquired TA may become inaccurate. In this example, the UE may still proceed with the uplink transmission (e.g., the UE self-scheduled uplink transmission) using the inaccurate TA, which may result in interference to data transmissions of other UEs in the plurality of UEs using the resource pool. In other words, when the plurality of UEs are configured with the same resource pool for UE self-scheduled uplink transmissions, by the network node, one uplink transmission that is transmitted using an inaccurate TA may cause interference for the other UEs that are using the same resource pool. The UE may reperform the random access procedure in order to obtain an accurate TA for the uplink transmission, but completing another random access procedure may result in additional delay for the uplink transmission. As a result, the inaccurate TA may cause interference to other UEs that are using the same resource pool and/or may cause the additional delay for the uplink transmission, thereby degrading an overall system performance.

Various aspects relate generally to self-scheduled uplink transmissions using resource pools associated with TA accuracies. In some examples, a UE may schedule its own uplink transmission using a resource from a resource pool. The resource may be a time-frequency domain resource. The resource pool may be one of multiple resource pools. The resource pool may be associated with one or more characteristics. The characteristics may be related to a guard band size, an allocation of multiple-user multiple-input multiple-output (MU-MIMO) resources, a modulation and coding scheme (MCS), a power level, demodulation reference signal (DMRS) density, and/or a phase tracking reference signal (PTRS) density. Different resource pools may have different combinations of characteristics (e.g., different resource pools may be associated with different guard band sizes, different allocations of MU-MIMO resources, different MCSs, different power levels, different DMRS densities, and/or different PTRS densities).

In some aspects, a guard band may be a narrow, intentionally unused frequency band that is placed between adjacent frequency bands to minimize interference between the two adjacent frequency bands. MU-MIMO is a wireless communication scheme for multipath wireless communication in which multiple UEs, each with one or more antennas, communication with one another. In contrast, single-user MIMO involves a single UE with multiple antennas communicating with one other UE. The MCS may define a number of useful bits that can be carried by one symbol. A DMRS is a reference signal that is used for channel estimation. The DMRS density may refer to a frequency of DMRSs within a certain period of time. A PTRS is a reference signal used for tracking a phase of a local oscillator at a receiver and a transmitter. The PTRS density may refer to a frequency of PTRSs within a certain period of time.

In some aspects, the TA acquired by the UE during a random access procedure may be a baseline TA, and when the TA accuracy diverges from the baseline TA by a defined threshold, the TA may be considered to be an inaccurate TA. When the TA accuracy is within the defined threshold, the TA may be considered to be an accurate TA. Thus, the TA accuracy may depend on a level of divergence from the baseline TA acquired during the random access procedure.

In some aspects, characteristics of a given resource pool may cause the resource pool to be more suitable or less suitable for a UE with a given TA accuracy. For example, when the TA is inaccurate, resource pools that are associated with larger guard bands, fewer MU-MIMO resources, lower MCSs, lower power levels, higher DMRS densities, and/or higher PTRS densities may be preferred to be used by the UE for the uplink transmission because such resource pools may be less likely to cause interference to other UEs, despite the inaccuracy of the TA. On the other hand, when the TA is accurate or within a defined accuracy level, resource pools that are associated with smaller guard bands, more MU-MIMO resources, higher MCSs, higher power levels, lower DMRS densities, and/or lower PTRS densities may be acceptable for the UE because such resource pools may be relatively unlikely to cause interference to other UEs.

In some aspects, a network node may indicate, to the UE, a mechanism that the UE is to use to estimate its timing accuracy. In a first mechanism, the TA accuracy may be based at least in part on a timing difference between separate TA values acquired by the UE. The timing difference satisfying a threshold may indicate TA inaccuracy. In a second mechanism, the TA accuracy may be based at least in part on a downlink signal measurement difference. The downlink signal measurement difference may be a difference in measurements between separate downlink reference signals. The downlink signal measurement difference satisfying a threshold may indicate TA inaccuracy. In a third mechanism, the TA accuracy may be based at least in part on a Doppler shift difference between separate Doppler shift values calculated by the UE. The UE may calculate Doppler shifts, which may change depending on a level of UE mobility over a period of time. The Doppler shift difference satisfying a threshold may indicate TA inaccuracy. Depending on which mechanism is instructed to be used by the UE, the network node may indicate a table of ranges and corresponding TA accuracy values. For example, when the timing difference is within a first range of values, a corresponding TA accuracy value may be a first value, when the timing difference is within a second range of values, a corresponding TA accuracy value may be a second value, and so on. The UE may be able to estimate its timing accuracy based on signaling received from the network node.

In some aspects, the network node may indicate, to the UE, a resource pool configuration. The resource pool configuration may indicate the multiple resource pools. The resource pool configuration may indicate, for each resource pool, one or more characteristics associated with that resource pool, and the TA accuracy associated with that resource pool. The UE, after estimating its TA accuracy based at least in part on signaling received from the network node, may look up the TA accuracy in the resource pool configuration. The UE may identify the resource pool that corresponds to the TA accuracy. The UE may use that resource pool to perform the uplink transmission. The UE may select the resource pool depending on a timing accuracy associated with the UE.

As an example, the resource pool configuration may indicate, for a first TA accuracy range, a first resource pool. The first resource pool may be associated with a relatively large guard band. The resource pool configuration may indicate, for a second TA accuracy range, a second resource pool. The second resource pool may be associated with a relatively small guard band. The UE may determine its TA accuracy is low (e.g., the UE has an inaccurate TA). In this example, the UE may select the first resource pool, and the UE may transmit the uplink transmission using the first resource pool.

As another example, the resource pool configuration may indicate, for a first TA accuracy range, a first resource pool. The first resource pool may be associated with a relatively high DMRS density. The resource pool configuration may indicate, for a second TA accuracy range, a second resource pool. The second resource pool may be associated with a relatively low DMRS density. The UE may determine its TA accuracy is high (e.g., the UE has an accurate TA). In this example, the UE may select the second resource pool, and the UE may transmit the uplink transmission using the first resource pool.

In some examples, by defining different resource pools with different characteristics for different TA accuracy levels, the described techniques can be used by the UE to select an appropriate resource pool for the uplink transmission. The network node may configure the multiple resource pools. The UE may obtain a TA value when initially accessing a wireless network. Since a timing accuracy of the UE may change over a period of time, the UE may determine its TA accuracy when uplink data is available for transmission. The UE may determine the TA accuracy and identify the corresponding resource pool using the table indicated by the network node. The resource pool may be associated with characteristics (e.g., guard band size, allocation of MU-MIMO resources, MCS, power level, DMRS density, and/or PTRS density) that are suited for the TA accuracy of the UE. By selecting the resource pool with such characteristics, the uplink transmission may be less likely to cause interference to other UEs using the same resource pool or adjacent resource pools. Further, by having an ability to select the resource pool based at least in part on the TA accuracy, the UE may not be forced to reobtain the TA value, which may involve additional signaling overhead and delay for the uplink transmission. As a result, a presence of an inaccurate TA may not necessarily cause inter-UE interference to the other UEs and/or cause additional signaling and delay, thereby improving an overall system performance.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

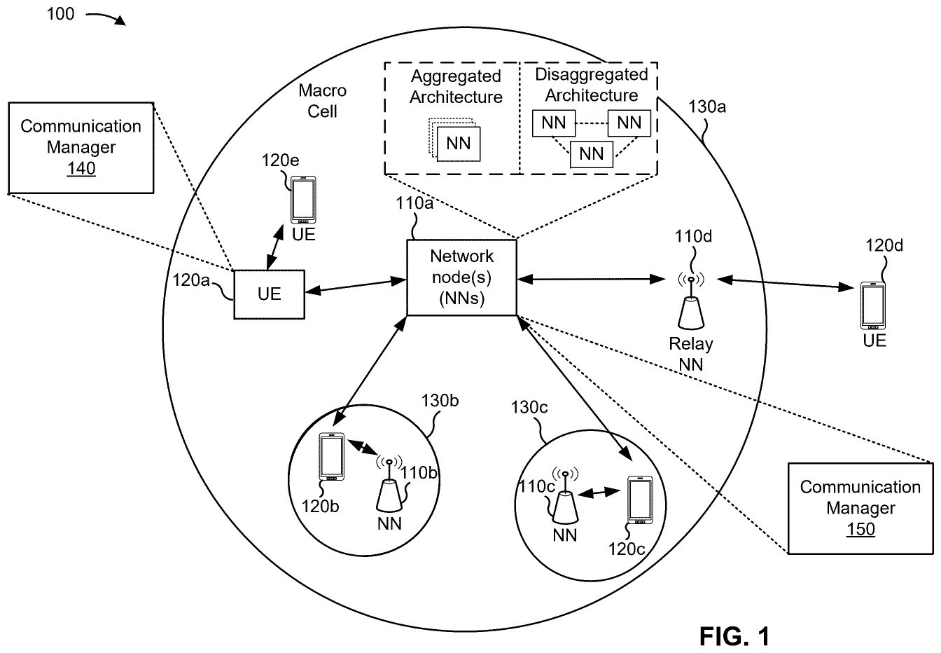

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). A processor also may be implemented as a combination of computing devices, for example, a combination of a DSP and a microprocessor, a plurality of microprocessors, one or more microprocessors in conjunction with a DSP core, or any other such configuration. One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as MU-MIMO. Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a UE (e.g., the UE 120) may include a communication manager 140. As described in more detail elsewhere herein, the communication manager 140 may receive a configuration that indicates a plurality of resource pools; select a resource pool from the plurality of resource pools based at least in part on a TA accuracy associated with the UE; and transmit, via a resource in the resource pool, an uplink transmission in accordance with a UE uplink self-scheduling. Additionally, or alternatively, the communication manager 140 may perform one or more other operations described herein.

In some aspects, a network node (e.g., the network node 110) may include a communication manager 150. As described in more detail elsewhere herein, the communication manager 150 may transmit a configuration that indicates a plurality of resource pools; and receive, via a resource in a resource pool of the plurality of resource pools, an uplink transmission, wherein the resource pool is associated with a TA accuracy of a UE. Additionally, or alternatively, the communication manager 150 may perform one or more other operations described herein.

As indicated above, FIG. 1 is provided as an example. Other examples may differ from what is described with regard to FIG. 1.

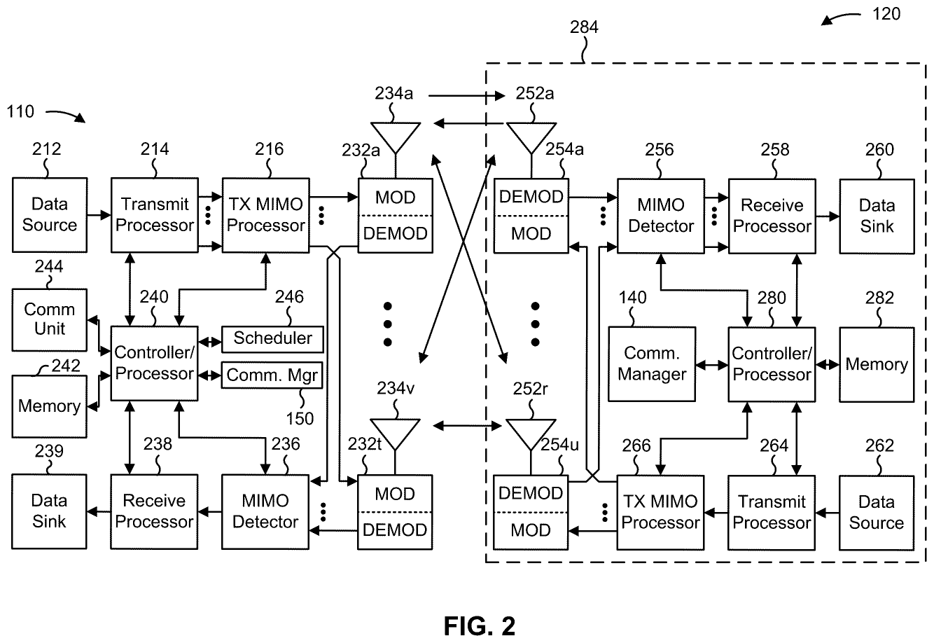

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a DMRS, or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

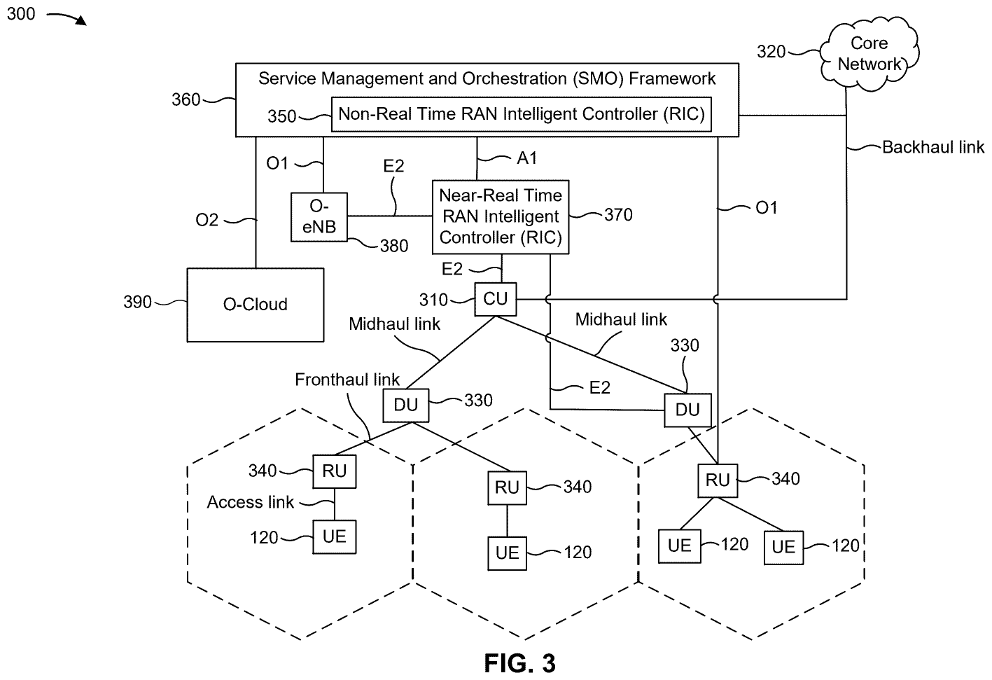

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

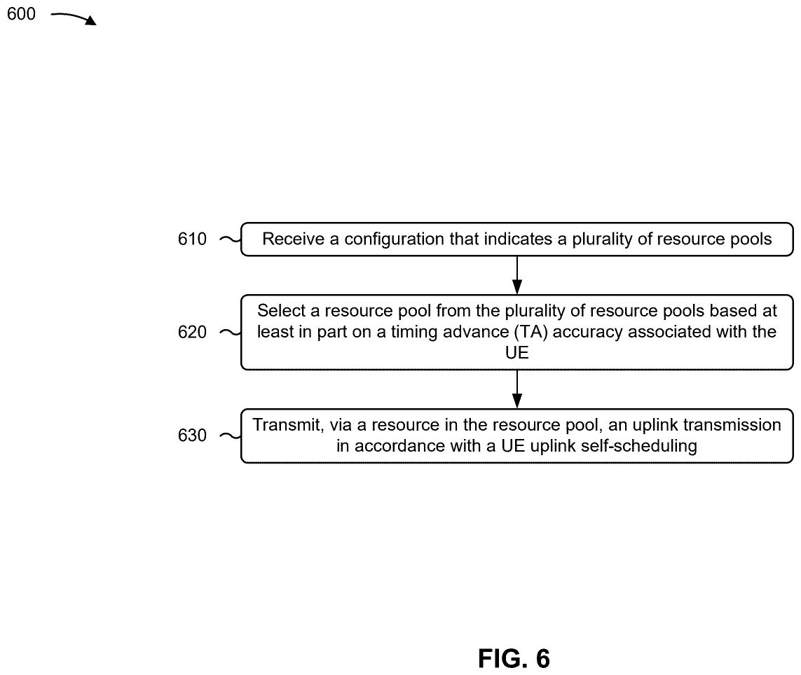

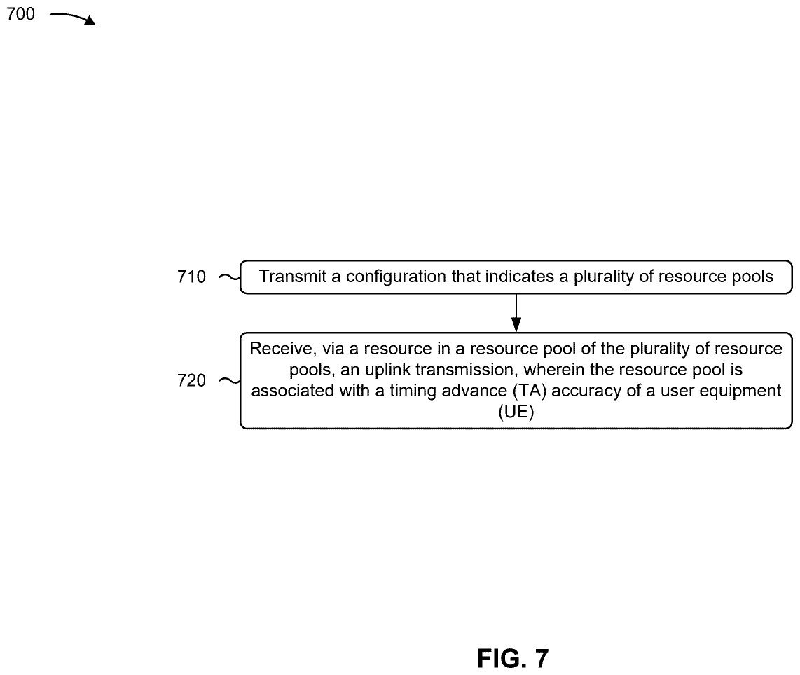

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with self-scheduled uplink transmissions using resource pools associated with TA accuracies, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 600 of FIG. 6, process 700 of FIG. 6, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 600 of FIG. 6, process 700 of FIG. 7, or other processes as described herein. In some examples, executing instructions may include running the instructions, converting the instructions, compiling the instructions, and/or interpreting the instructions, among other examples.

In some aspects, a UE (e.g., the UE 120) includes means for receiving a configuration that indicates a plurality of resource pools; means for selecting a resource pool from the plurality of resource pools based at least in part on a TA accuracy associated with the UE; and/or means for transmitting, via a resource in the resource pool, an uplink transmission in accordance with a UE uplink self-scheduling. In some aspects, the means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting a configuration that indicates a plurality of resource pools; and/or means for receiving, via a resource in a resource pool of the plurality of resource pools, an uplink transmission, wherein the resource pool is associated with a TA accuracy of a UE. In some aspects, the means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

A network node may schedule an uplink transmission for a UE in accordance with a per-UE uplink scheduling. The network node may transmit, to the UE, signaling to indicate an allocated resource. The allocated resource may be a time-frequency domain resource. The UE may perform the uplink transmission using the allocated resource. The uplink transmission may be a configured grant physical uplink shared channel (CG-PUSCH) transmission. When the UE is an IoT device, the uplink transmission may be associated with a relatively small data payload. In this example, a signaling overhead to indicate the allocated resource may be larger the uplink transmission itself.

An uplink transmission that is associated with a UE self-scheduling may reduce a network signaling overhead, in relation to the uplink transmission associated with the per-UE uplink scheduling. In this example, the network node may provide an indication of a resource pool for the uplink transmission. The resource pool may include a plurality of resources that are available for the UE to use for the uplink transmission. The resources may be time-frequency domain resources associated with a particular MCS and/or a DMRS pattern. When the UE has uplink data to transmit, the UE may randomly select a resource from the resource pool, and the UE may use that resource to perform the uplink transmission. With UE self-scheduling, the UE may not wait for an uplink grant from the network node. Rather, the UE may transmit in a randomly selected resource in the resource pool. The UE self-scheduling may be considered to be a CG-PUSCH enhancement, given that the network node does not allow full flexibility for the UE to schedule the uplink transmission itself, but rather the network node may provide a configuration and the resource pool to allow the UE to self-schedule its uplink transmission. The resource pool may be shared by a plurality of UEs. In other words, each of the UEs in the plurality of UEs may select a resource from the resource pool in order to perform self-scheduled uplink transmissions.

During an initial access, the UE may perform a PRACH procedure with the network node. The UE may request access to a network via the PRACH procedure. During the PRACH procedure, the UE may acquire a TA from the network node. The TA may be a command or notification from the network node that enables the UE to adjust its uplink transmission to the network node. The TA may be used to control an uplink transmission timing of the UE, which may ensure that uplink transmissions received from the plurality of UEs are synchronized when received by the network node. Depending on each UE's location, relative to the network node, the UE may apply a different TA, such that the plurality of uplink transmissions received from the plurality of UEs are synchronized when received by the network node. For example, when the UE is relatively close to the network node and has a shorter propagation delay, the TA may be relatively small, whereas when the UE is relatively far from the network node and has a longer propagation delay, the TA may be relatively large.

When an uplink traffic of the UE is relatively sparse (e.g., the UE has infrequent uplink transmissions), the TA acquired during the PRACH procedure may become inaccurate after a period of time, due to timing drift or a mobility of the UE. The timing draft may be a sampling clock drift. For example, when the UE move from a first location to a second location but does not reperform the PRACH procedure, the previously acquired TA may become inaccurate. In this example, the UE may still proceed with the uplink transmission (e.g., the UE self-scheduled uplink transmission) using the inaccurate TA, which may result in interference to other data transmissions of other UEs in the plurality of UEs using the resource pool. The UE may reperform the PRACH procedure in order to obtain an accurate TA for the uplink transmission, but completing another PRACH procedure may result in additional delay for the uplink transmission. The inaccurate TA at the UE may result in inter-cell interference (ICI) to the other data transmissions, and an impact of the ICI may reduce for frequencies that are relatively far away from current user data transmissions. The ICI may be an inter-UE interference (e.g., an interference between UEs). The inaccurate TA may cause interference to the other UEs that are using the same resource pool and/or may cause the additional delay for the uplink transmission, thereby degrading an overall system performance.

In various aspects of techniques and apparatuses described herein, a UE may schedule its own uplink transmission using a resource from a resource pool. The resource may be a time-frequency domain resource. The resource pool may be one of multiple resource pools. The resource pool may be associated with one or more characteristics. The characteristics may be related to a guard band size, an allocation of MU-MIMO resources, an MCS, a power level, DMRS density, and/or a PTRS density. Different resource pools may have different combinations of characteristics (e.g., different resource pools may be associated with different guard band sizes, different allocations of MU-MIMO resources, different MCSs, different power levels, different DMRS densities, and/or different PTRS densities).

In some aspects, characteristics of a given resource pool may cause the resource pool to be more suitable or less suitable for a UE with a given TA accuracy. For example, when the TA is relatively inaccurate, resource pools that are associated with larger guard bands, fewer MU-MIMO resources, lower MCSs, lower power levels, higher DMRS densities, and/or higher PTRS densities may be preferred to be used by the UE for the uplink transmission because such resource pools are less likely to cause interference to other UEs, despite the inaccuracy of the TA. On the other hand, when the TA is relatively accurate, resource pools that are associated with smaller guard bands, more MU-MIMO resources, higher MCSs, higher power levels, lower DMRS densities, and/or lower PTRS densities may be acceptable for the UE because such resource pools are relatively unlikely to cause interference to other UEs.

In some aspects, a network node may indicate, to the UE, a mechanism that the UE is to use to estimate its timing accuracy. In a first mechanism, the TA accuracy may be based at least in part on a timing difference between separate TA values acquired by the UE. The timing difference satisfying a threshold may indicate TA inaccuracy. In a second mechanism, the TA accuracy may be based at least in part on a downlink signal measurement difference. The downlink signal measurement difference may be a difference in measurements between separate downlink reference signals. The downlink signal measurement difference satisfying a threshold may indicate TA inaccuracy. In a third mechanism, the TA accuracy may be based at least in part on a Doppler shift difference between separate Doppler shift values calculated by the UE. The UE may calculate Doppler shifts, which may change depending on a level of UE mobility over a period of time. The Doppler shift difference satisfying a threshold may indicate TA inaccuracy. Depending on which mechanism is instructed to be used by the UE, the network node may indicate a table of ranges and corresponding TA accuracy values. For example, when the timing difference is within a first range of values, a corresponding TA accuracy value may be a first value, when the timing difference is within a second range of values, a corresponding TA accuracy value may be a second value, and so on. The UE may be able to estimate its timing accuracy based on signaling received from the network node.

In some aspects, the network node may indicate, to the UE, a resource pool configuration. The resource pool configuration may indicate the multiple resource pools. The resource pool configuration may indicate, for each resource pool, one or more characteristics associated with that resource pool, and the TA accuracy associated with that resource pool. The UE, after estimating its TA accuracy based at least in part on signaling received from the network node, may look up the TA accuracy in the resource pool configuration. The UE may identify the resource pool that corresponds to the TA accuracy. The UE may use that resource pool to perform the uplink transmission. The UE may select the resource pool depending on a timing accuracy associated with the UE.

In some examples, by defining different resource pools with different characteristics for different TA accuracy levels, the described techniques can be used by the UE to select an appropriate resource pool for the uplink transmission. The network node may configure the multiple resource pools. The UE may obtain a TA value when initially accessing a wireless network. Since a timing accuracy of the UE may change over a period of time, the UE may determine its TA accuracy when uplink data is available for transmission. The UE may determine the TA accuracy and identify the corresponding resource pool using the table indicated by the network node. The resource pool may be associated with characteristics (e.g., guard band size, allocation of MU-MIMO resources, MCS, power level, DMRS density, and/or PTRS density) that are suited for the TA accuracy of the UE. By selecting the resource pool with such characteristics, the uplink transmission may be less likely to cause interference to other UEs using the same resource pool or adjacent resource pools. Further, by having an ability to select the resource pool based at least in part on the TA accuracy, the UE may not be forced to reobtain the TA value, which may involve additional signaling overhead and delay for the uplink transmission. As a result, a presence of an inaccurate TA may not necessarily cause inter-UE interference to the other UEs and/or cause additional signaling and delay, thereby improving an overall system performance.

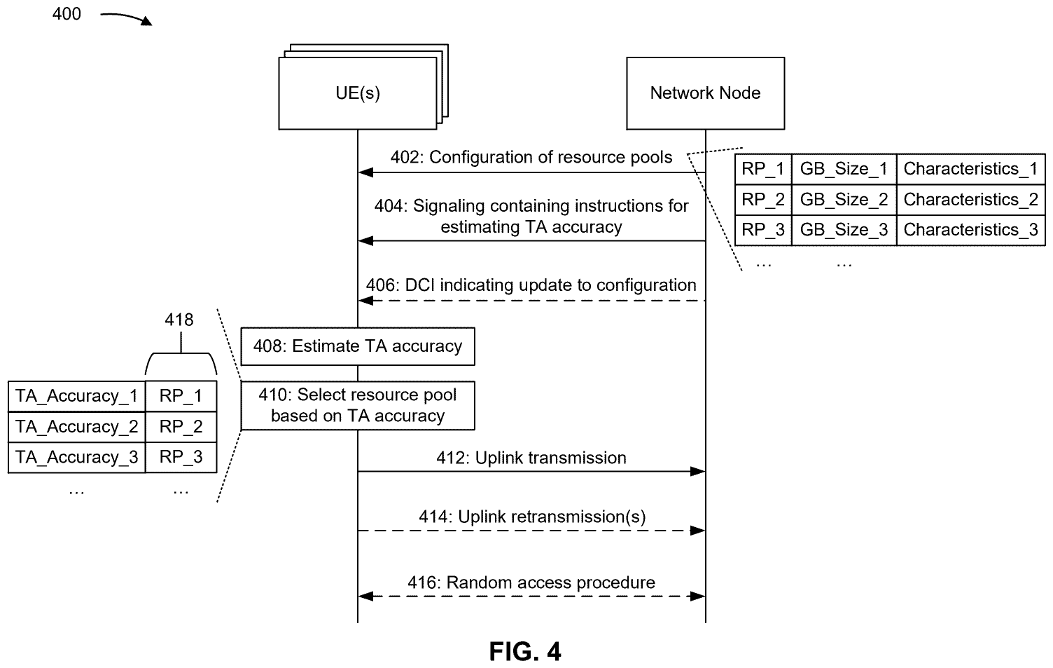

FIG. 4 is a diagram illustrating an example 400 associated with self-scheduled uplink transmissions using resource pools associated with TA accuracies, in accordance with the present disclosure. As shown in FIG. 4, example 400 includes communication between a UE (e.g., UE 120) and a network node (e.g., network node 110). In some aspects, the UE and the network node may be included in a wireless network, such as wireless network 100.

As shown by reference number 402, the UE may receive, from the network node, a configuration that indicates a plurality of resource pools 418. The network node may output the configuration that indicates the plurality of resource pools 418. Each resource pool 418, of the plurality of resource pools 418, may be associated with one or more characteristics. The one or more characteristics may be characteristics or parameters of the resource pool 418. The one or more characteristics may be related to a guard band (GB), an allocation of MU-MIMO resources, an MCS, a power limit, a DMRS density, and/or a PTRS density. The configuration may indicate a list of TA accuracy ranges, where each TA accuracy range in the list may be mapped to a corresponding resource pool 418 of the plurality of resource pools 418. The corresponding resource pool 418 may be associated with characteristics that serve to limit interference depending on the TA accuracy range.

As shown by reference number 404, the UE may receive, from the network node, signaling that contains instructions for estimating the TA accuracy based at least in part on a timing difference between TAs, a measurement difference between reference signals, or a Doppler shift difference between the reference signals. The signaling may include a table that indicates a list of timing difference ranges, measurement difference ranges, or Doppler shift difference ranges, and each range may be mapped to a corresponding TA accuracy. The network node may out the signaling that contains the instructions for estimating the TA accuracy.

As shown by reference number 406, the UE may receive, from the network node and via DCI, an update to the configuration, where the update may be in response to incoming traffic. The update may indicate updated resource pools 418 and/or updated characteristics associated with the updated resource pools 418. For example, the updated resource pools 418 may have different guard bands, different allocations of MU-MIMO resources, etc., in comparison to previous resource pools 418. The network node may output the update to the configuration.

As shown by reference number 408, the UE may estimate the TA accuracy based at least in part on the signaling. In some aspects, the UE may estimate the TA accuracy based at least in part on the timing difference between TAs. The UE may determine the timing difference between TAs, and then lookup the timing difference between TAs in a table to identify a corresponding TA accuracy. In some aspects, the UE may estimate the TA accuracy based at least in part on the measurement difference between reference signals. The UE may determine the measurement difference between reference signals, and then lookup the measurement difference between reference signals in a table to identify a corresponding TA accuracy. In some aspects, the UE may estimate the TA accuracy based at least in part on the Doppler shift difference between the reference signals. The UE may determine the Doppler shift difference between the reference signals, and then lookup the Doppler shift difference between the reference signals in a table to identify a corresponding TA accuracy.

In some aspects, the network node may indicate, to the UE, a configuration that enables the UE to estimate the TA accuracy. The network node may signal, to the UE, that one of a first option, a second option, or a third option is to be used by the UE to estimate the TA accuracy.

In some aspects, in the first option, the TA accuracy may be based at least in part on a timing difference from a previously acquired TA. A higher timing difference in relation to the previously acquired TA may indicate a more inaccurate TA. On the other hand, when the timing difference from the previously acquired TA is relatively small, the TA accuracy may be high. The network node may convey, to the UE, a table that indicates a mapping between the timing difference and the TA accuracy. The UE may identify a defined range that corresponds with the timing difference, and then the UE may identify an associated TA accuracy. In other words, when the timing difference is between the defined range, the network node may set a certain TA accuracy level. The UE may use the TA accuracy to select the resource for the uplink transmission. In one example, depending on the TA accuracy, the network node may directly configure the UE to perform the resource selection based at least in part on guard bands associated with resource pools 418, MU-MIMO resources associated with resource pools 418, an MCS associated with resource pools 418, a power level associated with resource pools 418, a DMRS density associated with resource pools 418, and/or a PTRS density associated with resource pools 418.

In some aspects, in the second option, the network node may indicate, to the UE, the TA accuracy based at least in part on a downlink RSRP difference. A higher downlink RSRP difference in relation to a previous downlink RSRP may indicate a more inaccurate TA. On the other hand, when a difference between downlink RSRP measurements of reference signals is relatively small, the TA accuracy may be high. The network node may convey, to the UE, a table that indicates a mapping between the downlink RSRP difference and the TA accuracy The UE may identify a defined range that corresponds with the downlink RSRP difference, and then the UE may identify an associated TA accuracy. In other words, when the downlink RSRP difference is between the defined range, the network node may set a certain TA accuracy level. The UE may use the TA accuracy to select the resource for the uplink transmission. In one example, depending on the TA accuracy, the network node may directly configure the UE to perform the resource selection based at least in part on guard bands associated with resource pools 418, MU-MIMO resources associated with resource pools 418, an MCS associated with resource pools 418, a power level associated with resource pools 418, a DMRS density associated with resource pools 418, and/or a PTRS density associated with resource pools 418.

In some aspects, in the third option, the network node may indicate, to the UE, the TA accuracy based at least in part on UE mobility and a timer. When the UE mobility is relatively high, the TA accuracy may degrade as the timer increases. In other words, when the UE is moving, the TA accuracy may start to decrease over a period of time. The UE may measure a Doppler shift from different types of reference signals, such as a tracking reference signal (TRS), CSI-RS, and/or a DMRS. The network node may convey, to the UE, a table that indicates a mapping between the Doppler shift and the TA accuracy. The UE may identify a defined range that corresponds with the Doppler shift, and then the UE may identify an associated TA accuracy. In other words, when the Doppler shift is between the defined range, the network node may set a certain TA accuracy level. The UE may use the TA accuracy to select the resource for the uplink transmission.

As shown by reference number 410, the UE may select a resource pool 418 from the plurality of resource pools 418 based at least in part on a TA accuracy associated with the UE. The UE may select the resource pool 418 based at least in part on the one or more characteristics associated with the resource pool 418. The resource pool 418 may be associated with a larger guard band size, a smaller allocation of MU-MIMO resources, a lower MCS, a lower power limit, a higher DMRS density, and/or a higher PTRS density, in relation to other resource pools 418 in the plurality of resource pools 418 and depending on the TA accuracy, to limit an amount of interference caused by an uplink transmission to other UE transmissions. The UE may access the list of TA accuracy ranges, where each TA accuracy range in the list may be mapped to a corresponding resource pool 418 of the plurality of resource pools 418, and based at least in part on the list, the UE may select the resource pool 418 that is associated with the TA accuracy.

In some aspects, multiple resource pools 418 (or multiple sub-resource pools 418 within a single resource pool 418) may be defined, and a resource pool 418 (or sub-resource pool 418) selection by the UE may be based at least in part on a TA accuracy. In other words, the UE may use a TA accuracy dependent selection mechanism among the multiple resource pools 418 (or sub-resource pools 418), which may reduce interference to other UEs that are also using the same resource pool 418. In some aspects, the multiple resource pools 418 may each be homogenous (e.g., each resource pool 418 may be associated with a same configuration). In some aspects, the single resource pool 418 may be heterogeneous, and multiple configurations may be associated with the multiple sub-resource pools 418, respectively.

In some aspects, the UE may perform a resource pool 418 (or sub-resource pool 418) selection based at least in part on a guard band (e.g., an inter-UE guard band). When the UE has an inaccurate TA accuracy, the UE may select a resource from a resource pool 418 with a higher guard band, in relation to resource pools 418 with smaller guard bands, which may help to reduce interference on another UE's transmission due to timing misalignment. Since an impact of the interference may reduce for frequencies that are relatively far away from current user data transmissions, the higher intra-user guard band associated with the resource pool 418 may be less likely to result in interference for the other UE transmissions. The network node may configure different guard bands in resource pools 418, and the network node may indicate such guard band configurations to the UE.

In some aspects, the network node may inform the UE regarding a computation of the TA accuracy. For example, the UE may measure the TA accuracy based at least in part on a TA difference, mobility of the UE, and/or an RSRP difference between signals associated with different time stamps. The UE may compute the TA accuracy based at least in part on signaling received from the network node. The network node may guide the UE on selecting an guard band based at least in part on the computed TA accuracy. For example, the network node may convey, to the UE, a table indicating range of TA accuracy levels for given guard bands. Different ranges may indicate different levels of TA accuracy (or different levels of TA inaccuracy). A specific TA accuracy may map to a given guard band, and that guard band may map to a specific resource pool 418 (or sub-resource pool 418) that the UE can use to perform an uplink transmission. The uplink transmission may be less likely to cause interference to other UE transmissions. In other words, after the UE computes the TA accuracy, the UE may use the table to look up a corresponding guard band.

In some aspects, when the TA accuracy, which may be associated with a TA accuracy error, exceeds a threshold (e.g., an inaccuracy of the TA is beyond a defined limit), the UE may initiate a PRACH procedure. The UE may obtain a new TA via the PRACH procedure, and then the UE may perform the uplink transmission. In this example, none of the resource pools 418 may be effective in eliminating or reducing the interference, so the UE may obtain the new TA using the PRACH procedure.

In some aspects, the UE may select a resource pool 418 with fewer or no MU-MIMO resources. When the UE is associated with TA inaccuracy, the UE may determine to transmit the uplink transmission in resources corresponding to fewer or no MU-MIMO transmissions. The TA inaccuracy may lead to DMRS non-orthogonality in the MU-MIMO resources, so using the MU-MIMO resources may have a higher impact on data interference. If the UE were to transmit the uplink transmission in the MU-MIMO resources, the uplink transmission may be more likely to cause interference to the other UE transmissions, as opposed to if the UE were to transmit the uplink transmission in non-MU-MIMO resources. In some aspects, the network node may convey, to the UE, a table regarding the selection of less or no MU-MIMO resources based at least in part on the TA accuracy. The UE may compute the TA accuracy. When the TA accuracy is within a given range, a defined number or percentage of MU-MIMO resources within a resource pool 418 may be permitted in accordance with the table. The defined number or percentage of MU-MIMO resources may be mapped to a given resource pool 418 in the table. The UE may use the given resource pool 418 to perform the uplink transmission. As a result, the UE may be able to select a resource pool 418 having an appropriate number of MU-MIMO resources (or no MU-MIMO resources) depending on the TA accuracy associated with the UE.

In some aspects, the UE may select a resource pool 418 with a lower MCS and/or a lower power level, in relation to other resource pools 418. When the UE is associated with TA inaccuracy, the UE may determine to transmit with the lower MCS and/or the lower power limit in order to limit interference to other UE transmissions. The network node may convey, to the UE, a table regarding the selection of resource pools 418 with the lower MCS and/or the lower power level based at least in part on the TA accuracy. When the TA accuracy is within a defined range, the UE may select a resource pool 418 with a defined MCS and/or power level in accordance with the table.

In some aspects, the UE may select a resource pool 418 with a higher DMRS density, in relation to other resource pools 418. When the UE is associated with the TA inaccuracy, the UE may select higher DMRS resources to effectively estimate and cancel the interference to the other UE transmissions. The network node may convey, to the UE, a table regarding the selection of resource pools 418 with the higher DMRS density based at least in part on the TA accuracy. When the TA accuracy is within a defined range, the UE may select a resource pool 418 with a defined DMRS density in accordance with the table.

In some aspects, the UE may select a resource pool 418 with a higher PTRS density, in relation to other resource pools 418. When the UE is associated with the TA inaccuracy, the UE may select higher PTRS resources to effectively estimate and cancel the interference to the other UE transmissions. The network node may convey, to the UE, a table regarding the selection of resource pools 418 with the higher PTRS density based at least in part on the TA accuracy. When the TA accuracy is within a defined range, the UE may select a resource pool 418 with a defined PTRS density in accordance with the table.

In some aspects, the network node may configure a mapping between a TA accuracy and different resource pools 418. The mapping may be configured as part of a resource pool configuration. In one example, the network node may dynamically change the mapping between the TA accuracy and an allocation of the different resources pools 418 based at least in part on other parameters, such as incoming traffic. The network node may transmit, to the UE, DCI that indicates an updated mapping between the TA accuracy and the allocation of the different resource pools 418. The UE may use the updated mapping when selecting an appropriate resource pool 418 for the uplink transmission.

As shown by reference number 412, the UE may transmit, to the network node, the uplink transmission using a resource in the resource pool 418 selected from the plurality of resource pools 418. The uplink transmission may be a UE self-scheduled uplink transmission. The uplink transmission may be less like to cause inter-UE interference to other UEs because the resource pool 418 may be selected in order to limit the likelihood of the inter-UE interference. The network node may obtain the uplink transmission.

As shown by reference number 414, the UE may transmit, to the network node, an uplink retransmission. For example, the UE may retransmit the uplink transmission when no acknowledgement is received from the network node. In other words, the network node may not acknowledge that the uplink transmission was successfully received.

As shown by reference number 416, the UE may initiate a random access procedure with the network node. The UE may initiate, after a defined number of unsuccessful retransmissions of the uplink transmission, the random access procedure to obtain a new TA to use when performing the uplink transmission. Alternatively, the UE may initiate the random access procedure to acquire the new TA based at least in part on the TA accuracy satisfying a defined threshold.

In some aspects, the UE may perform the uplink transmission, but the uplink transmission may not be successfully received by the network node, so the UE may perform a retransmission. When a number of retransmissions exceed a defined threshold (e.g., without acknowledgement on the success of reception), the UE may start the PRACH procedure and obtain a new TA. After the PRACH procedure is completed, the UE may perform the uplink transmission using the new TA. The network node may indicate, to the UE, a maximum number of repetitions that are allowed before the UE is to initiate the PRACH procedure. In one example, when the uplink transmission fails or the maximum number of repetitions is satisfied, the UE may fall back to using another resource pool 418, where the resource pool 418 may be better suited to handle TA inaccuracy.

As indicated above, FIG. 4 is provided as an example. Other examples may differ from what is described with regard to FIG. 4.

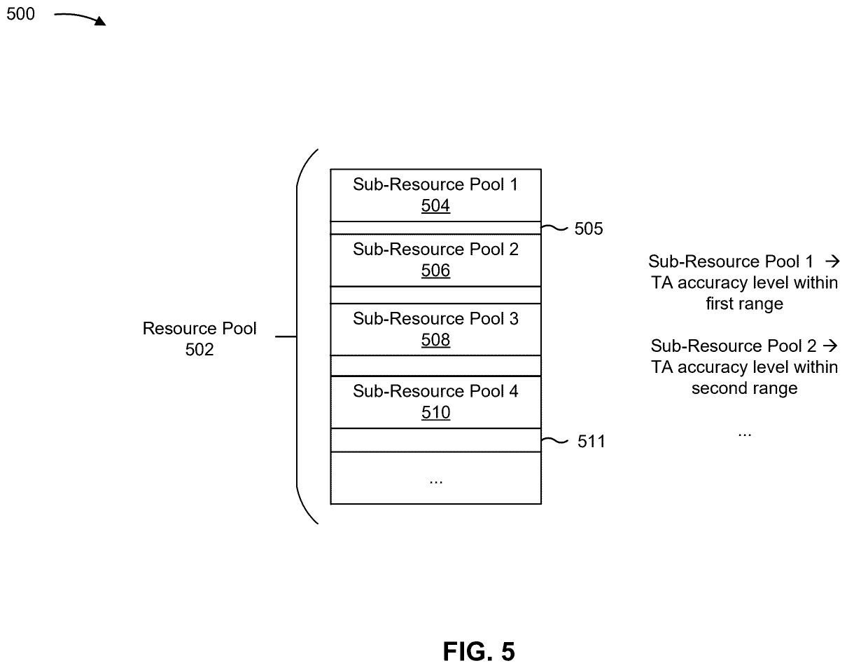

FIG. 5 is a diagram illustrating an example 500 associated with self-scheduled uplink transmissions using resource pools associated with TA accuracies, in accordance with the present disclosure.

As shown in FIG. 5, one resource pool 502 may be associated with four sub-resource pools, where each sub-resource pool may be associated with a guard band in a frequency domain. The resource pool 502 may include a first sub-resource pool 504, a second sub-resource pool 506, a third sub-resource pool 508, and a fourth sub-resource pool 510. The resource pool 502 may be a heterogeneous resource pool. The first sub-resource pool 504 may have a smallest guard band 505 and the fourth sub-resource pool 510 may have a largest guard band 511, among a plurality of guard bands. Among the four sub-resource pools, the fourth sub-resource pool 510 may be best suited for UEs with the most inaccurate TA, whereas the first sub-resource pool 504 may be best suited for UEs with the least inaccurate TA. Different guard bands associated with different sub-resource pools may be configured by a network node. When a TA accuracy level falls within a first range, the UE may use the first sub-resource pool 504, when the TA accuracy level falls with a second range, the UE may use the second sub-resource pool 506, and so on, where the second range may reflect greater TA inaccuracy as compared to the first range, or the first range may reflect greater TA inaccuracy as compared to the second range.

As indicated above, FIG. 5 is provided as an example. Other examples may differ from what is described with regard to FIG. 5.

FIG. 6 is a diagram illustrating an example process 600 performed, for example, at a UE or an apparatus of a UE, in accordance with the present disclosure. Example process 600 is an example where the apparatus or the UE (e.g., UE 120) performs operations associated with self-scheduled uplink transmissions using resource pools associated with TA accuracies.

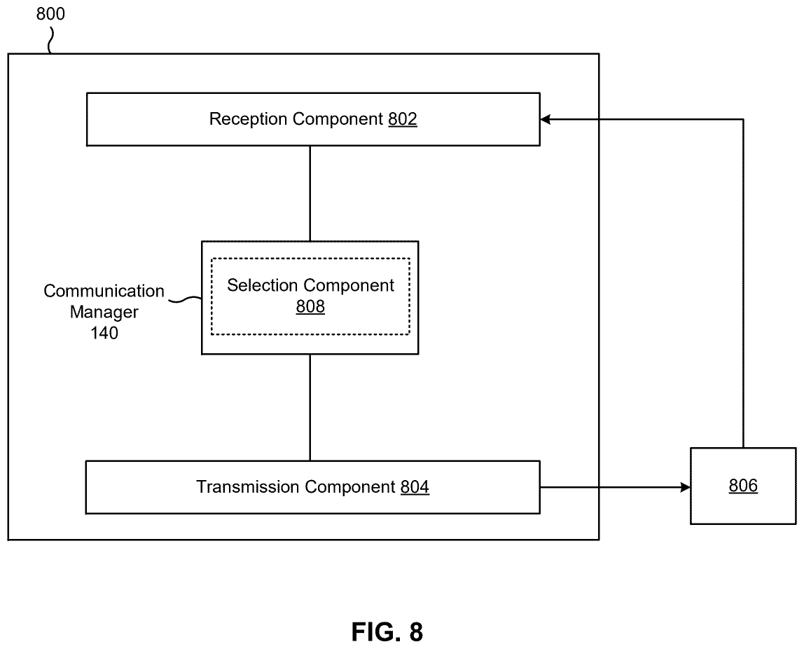

As shown in FIG. 6, in some aspects, process 600 may include receiving a configuration that indicates a plurality of resource pools (block 610). For example, the UE (e.g., using communication manager 140 and/or reception component 802, depicted in FIG. 8) may receive a configuration that indicates a plurality of resource pools, as described above.

As further shown in FIG. 6, in some aspects, process 600 may include selecting a resource pool from the plurality of resource pools based at least in part on a TA accuracy associated with the UE (block 620). For example, the UE (e.g., using communication manager 140 and/or selection component 808, depicted in FIG. 8) may select a resource pool from the plurality of resource pools based at least in part on a TA accuracy associated with the UE, as described above.

As further shown in FIG. 6, in some aspects, process 600 may include transmitting, via a resource in the resource pool, an uplink transmission in accordance with a UE uplink self-scheduling (block 630). For example, the UE (e.g., using communication manager 140 and/or transmission component 804, depicted in FIG. 8) may transmit, via a resource in the resource pool, an uplink transmission in accordance with a UE uplink self-scheduling, as described above.

Process 600 may include additional aspects, such as any single aspect or any combination of aspects described below and/or in connection with one or more other processes described elsewhere herein.

In a first aspect, the resource pool, of the plurality of resource pools, is associated with one or more characteristics, and the one or more characteristics are related to one or more of a guard band, an allocation of MU-MIMO resources, an MCS, a power limit, a DMRS density, or a PTRS density.

In a second aspect, alone or in combination with the first aspect, process 600 includes selecting the resource pool based at least in part on the one or more characteristics associated with the resource pool.

In a third aspect, alone or in combination with one or more of the first and second aspects, process 600 includes receiving signaling that contains one or more instructions for estimating the TA accuracy based at least in part on one of a time difference between TAs, a measurement difference between reference signals, or a Doppler shift difference between the reference signals, and estimating the TA accuracy based at least in part on the signaling.

In a fourth aspect, alone or in combination with one or more of the first through third aspects, the signaling indicates a list of time difference ranges, measurement difference ranges, or Doppler shift difference ranges, and each range is mapped to a corresponding TA accuracy.

In a fifth aspect, alone or in combination with one or more of the first through fourth aspects, the configuration indicates a list of TA accuracy ranges, wherein each TA accuracy range in the list is mapped to a corresponding resource pool of the plurality of resource pools, and the corresponding resource pool is associated with one or more characteristics that serve to limit interference based at least in part on the TA accuracy range.

In a sixth aspect, alone or in combination with one or more of the first through fifth aspects, process 600 includes receiving, via DCI, an update to the configuration.

In a seventh aspect, alone or in combination with one or more of the first through sixth aspects, process 600 includes initiating a random access procedure to acquire a new TA when the TA accuracy satisfies a defined threshold.

In an eighth aspect, alone or in combination with one or more of the first through seventh aspects, process 600 includes initiating, after a defined number of unsuccessful retransmissions of the uplink transmission, a random access procedure to obtain a new TA.

In a ninth aspect, alone or in combination with one or more of the first through eighth aspects, process 600 includes falling back to a different resource pool, of the plurality of resource pools, for the uplink transmission based at least in part on a lack of acknowledgement for the uplink transmission.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node, in accordance with the present disclosure. Example process 700 is an example where the apparatus or the network node (e.g., network node 110) performs operations associated with self-scheduled uplink transmissions using resource pools associated with TA accuracies.

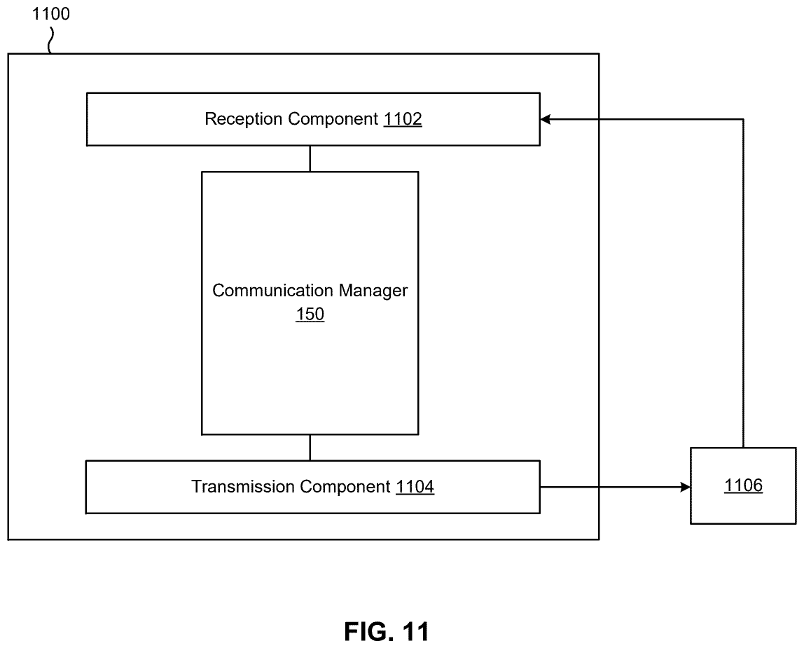

As shown in FIG. 7, in some aspects, process 700 may include outputting a configuration that indicates a plurality of resource pools (block 710). For example, the network node (e.g., using communication manager 150 and/or transmission component 1104, depicted in FIG. 11) may output a configuration that indicates a plurality of resource pools, as described above.

As further shown in FIG. 7, in some aspects, process 700 may include obtaining, via a resource in a resource pool of the plurality of resource pools, an uplink transmission, wherein the resource pool is associated with a TA accuracy of a UE (block 720). For example, the network node (e.g., using communication manager 150 and/or reception component 1102, depicted in FIG. 11) may obtain, via a resource in a resource pool of the plurality of resource pools, an uplink transmission, wherein the resource pool is associated with a TA accuracy of a UE, as described above.

Process 700 may include additional aspects, such as any single aspect or any combination of aspects described below and/or in connection with one or more other processes described elsewhere herein.

In a first aspect, the resource pool, of the plurality of resource pools, is associated with one or more characteristics, and the one or more characteristics are related to one or more of a guard band, an allocation of MU-MIMO resources, an MCS, a power limit, a DMRS density, or a PTRS density.

In a second aspect, alone or in combination with the first aspect, process 700 includes transmitting signaling that contains one or more instructions for estimating the TA accuracy based at least in part on one of a time difference between TAs, a measurement difference between reference signals, or a Doppler shift difference between the reference signals.

In a third aspect, alone or in combination with one or more of the first and second aspects, the signaling indicates a list of time difference ranges, measurement difference ranges, or Doppler shift difference ranges, and each range is mapped to a corresponding TA accuracy.

In a fourth aspect, alone or in combination with one or more of the first through third aspects, the configuration indicates a list of TA accuracy ranges, wherein each TA accuracy range in the list is mapped to a corresponding resource pool of the plurality of resource pools, and the corresponding resource pool is associated with one or more characteristics that serve to limit interference based at least in part on the TA accuracy range.

In a fifth aspect, alone or in combination with one or more of the first through fourth aspects, process 700 includes outputting, via DCI, an update to the configuration.

In a sixth aspect, alone or in combination with one or more of the first through fifth aspects, process 700 includes performing a random access when the TA accuracy satisfies a defined threshold.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 140. The communication manager 140 may include a selection component 808, among other examples.

In some aspects, the apparatus 800 may be configured to perform one or more operations described herein in connection with FIGS. 4-5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 804 may be co-located with the reception component 802 in one or more transceivers.

The reception component 802 may receive a configuration that indicates a plurality of resource pools. The selection component 808 may select a resource pool from the plurality of resource pools based at least in part on a TA accuracy associated with the UE. The transmission component 804 may transmit, via a resource in the resource pool, an uplink transmission in accordance with a UE uplink self-scheduling.

The reception component 802 may receive signaling that contains one or more instructions for estimating the TA accuracy based at least in part on one of: a time difference between TAs, a measurement difference between reference signals, or a Doppler shift difference between the reference signals. The reception component 802 may receive, via DCI, an update to the configuration.

The communication manager 140 may estimate the TA accuracy based at least in part on the signaling. The communication manager 140 may initiate a random access procedure to acquire a new TA when the TA accuracy satisfies a defined threshold. The communication manager 140 may initiate, after a defined number of unsuccessful retransmissions of the uplink transmission, a random access procedure to obtain a new TA. The communication manager 140 may fall back to a different resource pool, of the plurality of resource pools, for the uplink transmission based at least in part on a lack of acknowledgement for the uplink transmission.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

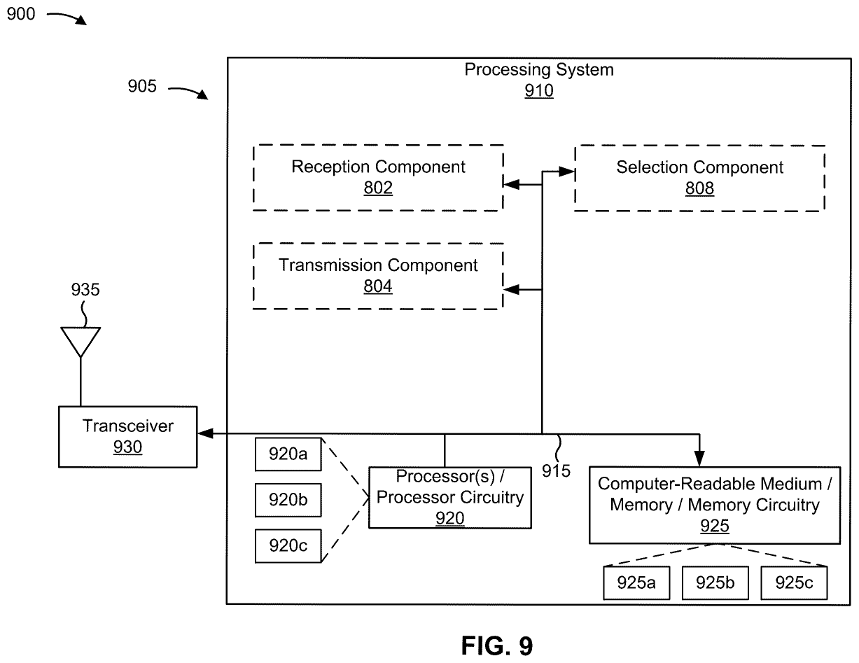

FIG. 9 is a diagram illustrating an example 900 of a hardware implementation for an apparatus 905 employing a processing system 910, in accordance with the present disclosure. The apparatus 905 may be a UE or may be at (e.g., included in) a UE.

The processing system 910 may be implemented with a bus architecture, represented generally by the bus 915. The bus 915 may include any number of interconnecting buses and bridges depending on the specific application of the processing system 910 and the overall design constraints. The bus 915 links together various circuits including one or more processors and/or hardware components, represented by the processor (or processing circuitry) 920, the illustrated components, and the computer-readable medium/memory (or memory circuitry) 925. The processor 920 may include multiple processors, such as processor 920a, memory 920b, and memory 920c. The memory 925 may include multiple memories, such as memory 925a, memory 925b, and memory 925c. The bus 915 may also link various other circuits, such as timing sources, peripherals, voltage regulators, and/or power management circuits.

The processing system 910 may be coupled to one or more transceivers 930. A transceiver 930 is coupled to one or more antennas 935. The transceiver 930 provides a means for communicating with various other apparatuses over a transmission medium. The transceiver 930 receives a signal from the one or more antennas 935, extracts information from the received signal, and provides the extracted information to the processing system 910, specifically the reception component 802. In addition, the transceiver 930 receives information from the processing system 910, specifically the transmission component 804, and generates a signal to be applied to the one or more antennas 935 based at least in part on the received information.

The processing system 910 includes one or more processors 920 coupled to a computer-readable medium/memory 925. A processor 920 is responsible for general processing, including the execution of software stored on the computer-readable medium/memory 925. The software, when executed by the processor 920, causes the processing system 910 to perform the various functions described herein for any particular apparatus. The computer-readable medium/memory 925 may also be used for storing data that is manipulated by the processor 920 when executing software. The processing system further includes at least one of the illustrated components. The components may be software modules running in the processor 920, resident/stored in the computer readable medium/memory 925, one or more hardware modules coupled to the processor 920, or some combination thereof.

In some aspects, the processing system 910 may be a component of the UE 120 and may include one or more memories, such as the memory 282, and/or may include one or more processors, such as at least one of the TX MIMO processor 266, the Rx processor 258, and/or the controller/processor 280. In some aspects, the apparatus 905 for wireless communication includes means for receiving a configuration that indicates a plurality of resource pools; means for selecting a resource pool from the plurality of resource pools based at least in part on a TA accuracy associated with the apparatus 905, and/or means for transmitting, via a resource in the resource pool, an uplink transmission in accordance with a UE uplink self-scheduling

The aforementioned means may be one or more of the aforementioned components of the apparatus 800 and/or the processing system 910 of the apparatus 905 configured to perform the functions recited by the aforementioned means. As described elsewhere herein, the processing system 910 may include the TX MIMO processor 266, the Rx processor 258, and/or the controller/processor 280. In one configuration, the aforementioned means may be the TX MIMO processor 266, the Rx processor 258, and/or the controller/processor 280 configured to perform the functions and/or operations recited herein.

FIG. 9 is provided as an example. Other examples may differ from what is described in connection with FIG. 9.

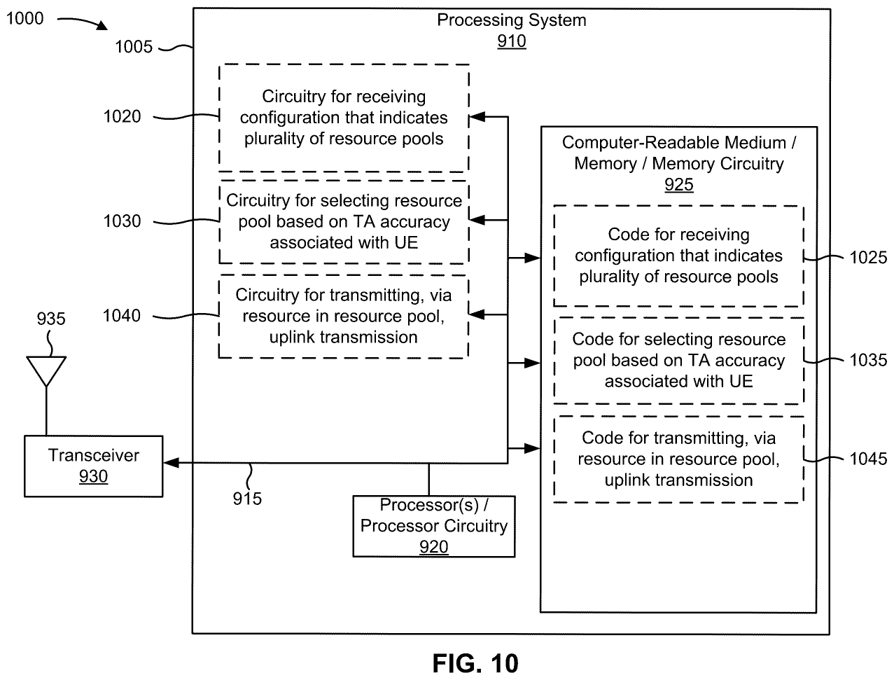

FIG. 10 is a diagram illustrating an example 1000 of an implementation of code and circuitry for an apparatus 1005, in accordance with the present disclosure. The circuitry may include processing circuitry and memory circuitry. The apparatus 1005 may be a UE, or a UE may include the apparatus 1005.

As shown in FIG. 10, the apparatus 1005 may include circuitry for receiving a configuration that indicates a plurality of resource pools (circuitry 1020). For example, the circuitry 1020 may enable the apparatus 1005 to receive a configuration that indicates a plurality of resource pools.

As shown in FIG. 10, the apparatus 1005 may include, stored in computer-readable medium 925, code for receiving a configuration that indicates a plurality of resource pools (code 1025). For example, the code 1025, when executed by processor 920, may cause processor 920 to cause transceiver 930 to receive a configuration that indicates a plurality of resource pools.

As shown in FIG. 10, the apparatus 1005 may include circuitry for selecting a resource pool from the plurality of resource pools based at least in part on a TA accuracy associated with the UE (circuitry 1030). For example, the circuitry 1030 may enable the apparatus 1005 to select a resource pool from the plurality of resource pools based at least in part on a TA accuracy associated with the UE.

As shown in FIG. 10, the apparatus 1005 may include, stored in computer-readable medium 925, code for selecting a resource pool from the plurality of resource pools based at least in part on a TA accuracy associated with the UE (code 1035). For example, the code 1035, when executed by processor 920, may cause processor 920 to cause transceiver 930 to select a resource pool from the plurality of resource pools based at least in part on a TA accuracy associated with the UE.

As shown in FIG. 10, the apparatus 1005 may include circuitry for transmitting, via a resource in the resource pool, an uplink transmission in accordance with a UE uplink self-scheduling (circuitry 1040). For example, the circuitry 1040 may enable the apparatus 1005 to transmit, via a resource in the resource pool, an uplink transmission in accordance with a UE uplink self-scheduling.

As shown in FIG. 10, the apparatus 1005 may include, stored in computer-readable medium 925, code for transmitting, via a resource in the resource pool, an uplink transmission in accordance with a UE uplink self-scheduling (code 1045). For example, the code 1045, when executed by processor 920, may cause processor 920 to cause transceiver 930 to transmit, via a resource in the resource pool, an uplink transmission in accordance with a UE uplink self-scheduling.

FIG. 10 is provided as an example. Other examples may differ from what is described in connection with FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150.

In some aspects, the apparatus 1100 may be configured to perform one or more operations described herein in connection with FIGS. 4-5. Additionally, or alternatively, the apparatus 1100 may be configured to perform one or more processes described herein, such as process 700 of FIG. 7. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1104 may be co-located with the reception component 1102 in one or more transceivers.

The transmission component 1104 may transmit a configuration that indicates a plurality of resource pools. The reception component 1102 may receive, via a resource in a resource pool of the plurality of resource pools, an uplink transmission, wherein the resource pool is associated with a TA accuracy of a UE.

The transmission component 1104 may transmit signaling that contains one or more instructions for estimating the TA accuracy based at least in part on one of: a time difference between TAs, a measurement difference between reference signals, or a Doppler shift difference between the reference signals. The transmission component 1104 may transmit, via DCI, an update to the configuration.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

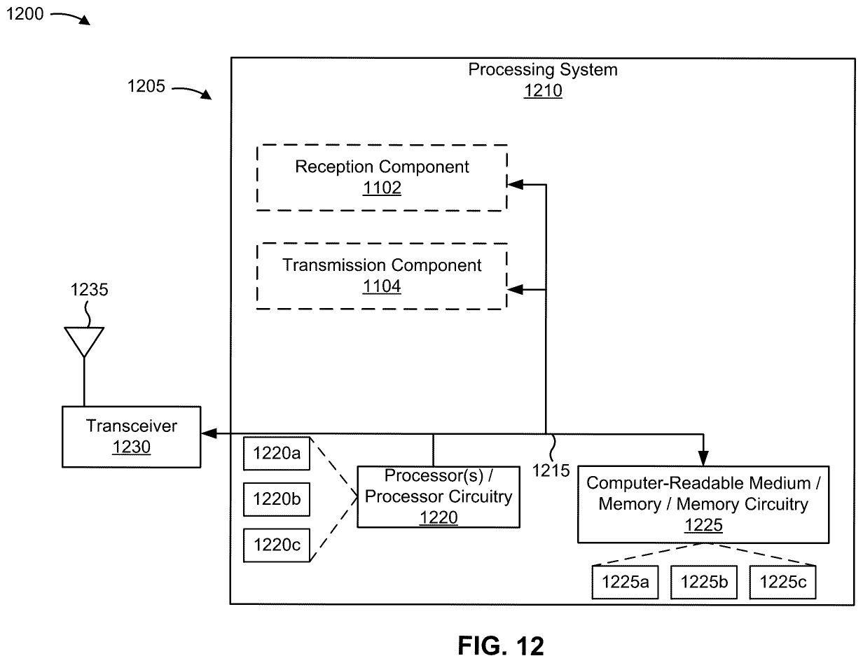

FIG. 12 is a diagram illustrating an example 1200 of a hardware implementation for an apparatus 1205 employing a processing system 1210, in accordance with the present disclosure. The apparatus 1205 may be a network node or may be at (e.g., included in) a network node.

The processing system 1210 may be implemented with a bus architecture, represented generally by the bus 1215. The bus 1215 may include any number of interconnecting buses and bridges depending on the specific application of the processing system 1210 and the overall design constraints. The bus 1215 links together various circuits including one or more processors and/or hardware components, represented by the processor (or processing circuitry) 1220, the illustrated components, and the computer-readable medium/memory (or memory circuitry) 1225. The processor 1220 may include multiple processors, such as processor 1220a, memory 1220b, and memory 1220c. The memory 1225 may include multiple memories, such as memory 1225a, memory 1225b, and memory 1225c. The bus 1215 may also link various other circuits, such as timing sources, peripherals, voltage regulators, and/or power management circuits.

The processing system 1210 may be coupled to one or more transceivers 1230. A transceiver 1230 is coupled to one or more antennas 1235. The transceiver 1230 provides a means for communicating with various other apparatuses over a transmission medium. The transceiver 1230 receives a signal from the one or more antennas 1235, extracts information from the received signal, and provides the extracted information to the processing system 1210, specifically the reception component 1102. In addition, the transceiver 1230 receives information from the processing system 1210, specifically the transmission component 1104, and generates a signal to be applied to the one or more antennas 1235 based at least in part on the received information.

The processing system 1210 includes one or more processors 1220 coupled to a computer-readable medium/memory 1225. A processor 1220 is responsible for general processing, including the execution of software stored on the computer-readable medium/memory 1225. The software, when executed by the processor 1220, causes the processing system 1210 to perform the various functions described herein for any particular apparatus. The computer-readable medium/memory 1225 may also be used for storing data that is manipulated by the processor 1220 when executing software.

The processing system further includes at least one of the illustrated components. The components may be software modules running in the processor 1220, resident/stored in the computer readable medium/memory 1225, one or more hardware modules coupled to the processor 1220, or some combination thereof.

In some aspects, the processing system 1210 may be a component of the network node 110 and may include one or more memories, such as the memory 242, and/or may include one or more processors, such as at least one of the TX MIMO processor 216, the Rx processor 238, and/or the controller/processor 240. In some aspects, the apparatus 1205 for wireless communication includes means for transmitting a configuration that indicates a plurality of resource pools; and/or means for receiving, via a resource in a resource pool of the plurality of resource pools, an uplink transmission, wherein the resource pool is associated with a TA accuracy of a UE. The aforementioned means may be one or more of the aforementioned components of the apparatus 1100 and/or the processing system 1210 of the apparatus 1205 configured to perform the functions recited by the aforementioned means. As described elsewhere herein, the processing system 1210 may include the TX MIMO processor 216, the receive processor 238, and/or the controller/processor 240. In one configuration, the aforementioned means may be the TX MIMO processor 216, the receive processor 238, and/or the controller/processor 240 configured to perform the functions and/or operations recited herein.

FIG. 12 is provided as an example. Other examples may differ from what is described in connection with FIG. 12.

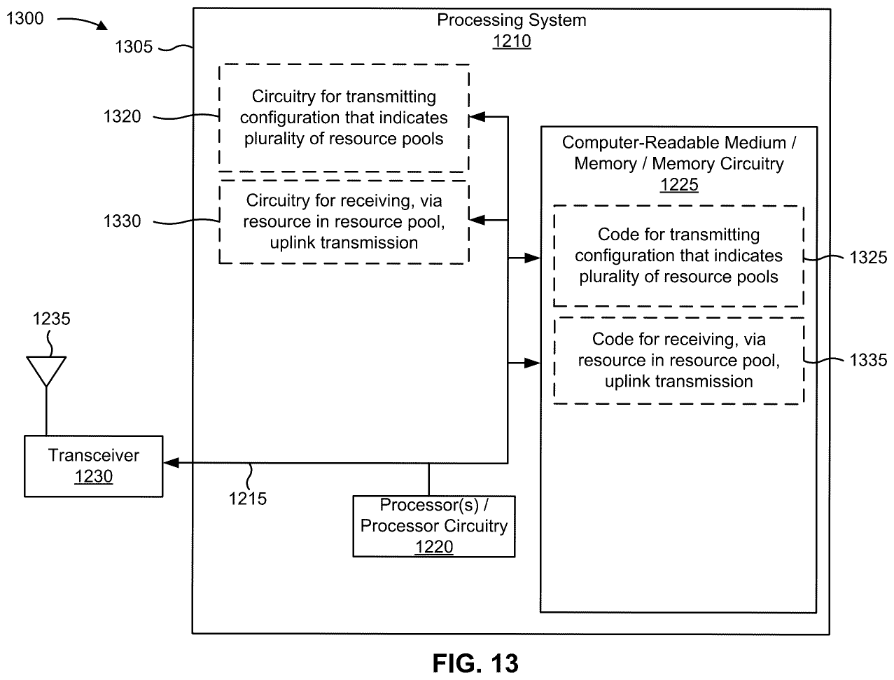

FIG. 13 is a diagram illustrating an example 1300 of an implementation of code and circuitry for an apparatus 1305, in accordance with the present disclosure. The circuitry may include processing circuitry and memory circuitry. The apparatus 1305 may be a UE, or a UE may include the apparatus 1305.

As shown in FIG. 13, the apparatus 1305 may include circuitry for transmitting a configuration that indicates a plurality of resource pools (circuitry 1320). For example, the circuitry 1320 may enable the apparatus 1305 to transmit a configuration that indicates a plurality of resource pools.

As shown in FIG. 13, the apparatus 1305 may include, stored in computer-readable medium 1225, code for transmitting a configuration that indicates a plurality of resource pools (code 1325). For example, the code 1325, when executed by processor 1220, may cause processor 1220 to cause transceiver 1230 to transmit a configuration that indicates a plurality of resource pools.

As shown in FIG. 13, the apparatus 1305 may include circuitry for receiving, via a resource in a resource pool of the plurality of resource pools, an uplink transmission, wherein the resource pool is associated with a TA accuracy of a UE (circuitry 1330). For example, the circuitry 1330 may enable the apparatus 1305 to receive, via a resource in a resource pool of the plurality of resource pools, an uplink transmission, wherein the resource pool is associated with a TA accuracy of a UE.

As shown in FIG. 13, the apparatus 1305 may include, stored in computer-readable medium 1225, code for receiving, via a resource in a resource pool of the plurality of resource pools, an uplink transmission, wherein the resource pool is associated with a TA accuracy of a UE (code 1335). For example, the code 1335, when executed by processor 1220, may cause processor 1220 to cause transceiver 1230 to receive, via a resource in a resource pool of the plurality of resource pools, an uplink transmission, wherein the resource pool is associated with a TA accuracy of a UE.

FIG. 13 is provided as an example. Other examples may differ from what is described in connection with FIG. 13.

The following provides an overview of some Aspects of the present disclosure:

Aspect 1: A method of wireless communication performed at a user equipment (UE), comprising: receiving a configuration that indicates a plurality of resource pools; selecting a resource pool from the plurality of resource pools based at least in part on a timing advance (TA) accuracy associated with the UE; and transmitting, via a resource in the resource pool, an uplink transmission in accordance with a UE uplink self-scheduling.

Aspect 2: The method of Aspect 1, wherein the resource pool, of the plurality of resource pools, is associated with one or more characteristics.

Aspect 3: The method of Aspect 2, wherein the one or more characteristics are related to one or more of: a guard band, an allocation of multiple-user multiple-input multiple-output (MU-MIMO) resources, a modulation and coding scheme (MCS), a power limit, a demodulation reference signal (DMRS) density, or a phase tracking reference signal (PTRS) density.

Aspect 4: The method of Aspect 2, wherein selecting the resource pool is based at least in part on the one or more characteristics associated with the resource pool.

Aspect 5: The method of any of Aspects 1-4, further comprising: receiving signaling that contains one or more instructions for estimating the TA accuracy based at least in part on one of: a time difference between TAs, a measurement difference between reference signals, or a Doppler shift difference between the reference signals; and estimating the TA accuracy based at least in part on the signaling.

Aspect 6: The method of Aspect 5, wherein the signaling indicates a list of time difference ranges, measurement difference ranges, or Doppler shift difference ranges.

Aspect 7: The method of Aspect 6, wherein each range is mapped to a corresponding TA accuracy.

Aspect 8: The method of any of Aspects 1-7, wherein the configuration indicates a list of TA accuracy ranges.

Aspect 9: The method of Aspect 8, wherein each TA accuracy range in the list is mapped to a corresponding resource pool of the plurality of resource pools.

Aspect 10: The method of Aspect 9, wherein the corresponding resource pool is associated with one or more characteristics that serve to limit interference based at least in part on the TA accuracy range.

Aspect 11: The method of any of Aspects 1-10, further comprising: receiving, via downlink control information (DCI), an update to the configuration.

Aspect 12: The method of any of Aspects 1-11, further comprising: initiating a random access procedure to acquire a new TA when the TA accuracy satisfies a defined threshold.

Aspect 13: The method of any of Aspects 1-12, further comprising: initiating, after a defined number of unsuccessful retransmissions of the uplink transmission, a random access procedure to obtain a new TA.

Aspect 14: The method of any of Aspects 1-13, further comprising: falling back to a different resource pool, of the plurality of resource pools, for the uplink transmission based at least in part on a lack of acknowledgement for the uplink transmission.

Aspect 15: A method of wireless communication performed at a network node, comprising: transmitting a configuration that indicates a plurality of resource pools; and receiving, via a resource in a resource pool of the plurality of resource pools, an uplink transmission, wherein the resource pool is associated with a timing advance (TA) accuracy of a user equipment (UE).

Aspect 16: The method of Aspect 15, wherein the resource pool, of the plurality of resource pools, is associated with one or more characteristics.

Aspect 17: The method of Aspect 16, wherein the one or more characteristics are related to one or more of: a guard band, an allocation of multiple-user multiple-input multiple-output (MU-MIMO) resources, a modulation and coding scheme (MCS), a power limit, a demodulation reference signal (DMRS) density, or a phase tracking reference signal (PTRS) density.

Aspect 18: The method of any of Aspects 15-17, further comprising: transmitting signaling that contains one or more instructions for estimating the TA accuracy based at least in part on one of: a time difference between TAs, a measurement difference between reference signals, or a Doppler shift difference between the reference signals.

Aspect 19: The method of Aspect 18, wherein the signaling indicates a list of time difference ranges, measurement difference ranges, or Doppler shift difference ranges.

Aspect 20: The method of Aspect 19, wherein each range is mapped to a corresponding TA accuracy.

Aspect 21: The method of any of Aspects 15-20, wherein the configuration indicates a list of TA accuracy ranges.

Aspect 22: The method of Aspect 21, wherein each TA accuracy range in the list is mapped to a corresponding resource pool of the plurality of resource pools.

Aspect 23: The method of Aspect 22, wherein the corresponding resource pool is associated with one or more characteristics that serve to limit interference based at least in part on the TA accuracy range.

Aspect 24: The method of any of Aspects 15-23, further comprising: transmitting, via downlink control information (DCI), an update to the configuration.

Aspect 25: The method of any of Aspects 15-24, further comprising: performing a random access when the TA accuracy satisfies a defined threshold.

Aspect 26: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-14.

Aspect 27: An apparatus for wireless communication at a device, the apparatus comprising one or more memories and one or more processors coupled to the one or more memories, the one or more processors configured to cause the device to perform the method of one or more of Aspects 1-14.

Aspect 28: An apparatus for wireless communication, the apparatus comprising at least one means for performing the method of one or more of Aspects 1-14.

Aspect 29: A non-transitory computer-readable medium storing code for wireless communication, the code comprising instructions executable by one or more processors to perform the method of one or more of Aspects 1-14.

Aspect 30: A non-transitory computer-readable medium storing a set of instructions for wireless communication, the set of instructions comprising one or more instructions that, when executed by one or more processors of a device, cause the device to perform the method of one or more of Aspects 1-14.

Aspect 31: A device for wireless communication, the device comprising a processing system that includes one or more processors and one or more memories coupled with the one or more processors, the processing system configured to cause the device to perform the method of one or more of Aspects 1-14.

Aspect 32: An apparatus for wireless communication at a user equipment (UE), comprising: a processing system that includes processor circuitry and memory circuitry that stores code and is coupled with the processor circuitry, the processing system configured to cause the UE to perform the method of one or more of Aspects 1-14.

Aspect 33: An apparatus for wireless communication at a user equipment (UE), the apparatus comprising one or more memories and one or more processors coupled to the one or more memories, the one or more processors configured to individually or collectively cause the UE to perform the method of one or more of Aspects 1-14.

Aspect 34: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 15-25.

Aspect 35: An apparatus for wireless communication at a device, the apparatus comprising one or more memories and one or more processors coupled to the one or more memories, the one or more processors configured to cause the device to perform the method of one or more of Aspects 15-25.

Aspect 36: An apparatus for wireless communication, the apparatus comprising at least one means for performing the method of one or more of Aspects 15-25.

Aspect 37: A non-transitory computer-readable medium storing code for wireless communication, the code comprising instructions executable by one or more processors to perform the method of one or more of Aspects 15-25.

Aspect 38: A non-transitory computer-readable medium storing a set of instructions for wireless communication, the set of instructions comprising one or more instructions that, when executed by one or more processors of a device, cause the device to perform the method of one or more of Aspects 15-25.

Aspect 39: A device for wireless communication, the device comprising a processing system that includes one or more processors and one or more memories coupled with the one or more processors, the processing system configured to cause the device to perform the method of one or more of Aspects 15-25.

Aspect 40: An apparatus for wireless communication at a user equipment (UE), comprising: a processing system that includes processor circuitry and memory circuitry that stores code and is coupled with the processor circuitry, the processing system configured to cause the UE to perform the method of one or more of Aspects 15-25.

Aspect 41: An apparatus for wireless communication at a user equipment (UE), the apparatus comprising one or more memories and one or more processors coupled to the one or more memories, the one or more processors configured to individually or collectively cause the UE to perform the method of one or more of Aspects 15-25.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors coupled with the one or more memories and configured to cause the UE to:
receive a configuration that indicates a plurality of resource pools;
select a resource pool from the plurality of resource pools based at least in part on a timing advance (TA) accuracy associated with the UE; and
transmit, via a resource in the resource pool, an uplink transmission in accordance with a UE uplink self-scheduling.

2. The apparatus of claim 1, wherein the resource pool, of the plurality of resource pools, is associated with one or more characteristics, and the one or more characteristics are related to one or more of: a guard band, an allocation of multiple-user multiple-input multiple-output (MU-MIMO) resources, a modulation and coding scheme (MCS), a power limit, a demodulation reference signal (DMRS) density, or a phase tracking reference signal (PTRS) density.

3. The apparatus of claim 2, wherein the one or more processors are configured to cause the UE to select the resource pool based at least in part on the one or more characteristics associated with the resource pool.

4. The apparatus of claim 1, wherein the one or more processors are configured to cause the UE to:
receive signaling that contains one or more instructions to estimate the TA accuracy based at least in part on one of: a time difference between TAs, a measurement difference between reference signals, or a Doppler shift difference between the reference signals; and
estimate the TA accuracy based at least in part on the signaling.

5. The apparatus of claim 4, wherein the signaling indicates a list of time difference ranges, measurement difference ranges, or Doppler shift difference ranges, and each range is mapped to a corresponding TA accuracy.

6. The apparatus of claim 1, wherein the configuration indicates a list of TA accuracy ranges, wherein each TA accuracy range in the list is mapped to a corresponding resource pool of the plurality of resource pools, and the corresponding resource pool is associated with one or more characteristics that serve to limit interference based at least in part on the TA accuracy range.

7. The apparatus of claim 1, wherein the one or more processors are configured to cause the UE to:
receive, via downlink control information (DCI), an update to the configuration.

8. The apparatus of claim 1, wherein the one or more processors are configured to cause the UE to:
initiate a random access procedure to acquire a new TA when the TA accuracy satisfies a defined threshold.

9. The apparatus of claim 1, wherein the one or more processors are configured to cause the UE to:
initiate, after a defined number of unsuccessful retransmissions of the uplink transmission, a random access procedure to obtain a new TA.

10. The apparatus of claim 1, wherein the one or more processors are configured to cause the UE to:
fall back to a different resource pool, of the plurality of resource pools, for the uplink transmission based at least in part on a lack of acknowledgement for the uplink transmission.

11. An apparatus for wireless communication at a network node, comprising:
one or more memories; and
one or more processors coupled with the one or more memories and configured to cause the network node to:
output a configuration that indicates a plurality of resource pools; and
obtain, via a resource in a resource pool of the plurality of resource pools, an uplink transmission, wherein the resource pool is associated with a timing advance (TA) accuracy of a user equipment (UE).

12. The apparatus of claim 11, wherein the resource pool, of the plurality of resource pools, is associated with one or more characteristics, and the one or more characteristics are related to one or more of: a guard band, an allocation of multiple-user multiple-input multiple-output (MU-MIMO) resources, a modulation and coding scheme (MCS), a power limit, a demodulation reference signal (DMRS) density, or a phase tracking reference signal (PTRS) density.

13. The apparatus of claim 11, wherein the one or more processors are configured to cause the network node to:
output signaling that contains one or more instructions to estimate the TA accuracy based at least in part on one of: a time difference between TAs, a measurement difference between reference signals, or a Doppler shift difference between the reference signals.

14. The apparatus of claim 13, wherein the signaling indicates a list of time difference ranges, measurement difference ranges, or Doppler shift difference ranges, and each range is mapped to a corresponding TA accuracy.

15. The apparatus of claim 11, wherein the configuration indicates a list of TA accuracy ranges, wherein each TA accuracy range in the list is mapped to a corresponding resource pool of the plurality of resource pools, and the corresponding resource pool is associated with one or more characteristics that serve to limit interference based at least in part on the TA accuracy range.

16. The apparatus of claim 11, wherein the one or more processors are configured to cause the network node to:
output, via downlink control information (DCI), an update to the configuration.

17. The apparatus of claim 11, wherein the one or more processors are configured to cause the network node to:
identify that the TA accuracy satisfies a defined threshold; and
perform a random access in response to the TA accuracy satisfying the defined threshold.

18. A method of wireless communication performed at a user equipment (UE), comprising:
receiving a configuration that indicates a plurality of resource pools;
selecting a resource pool from the plurality of resource pools based at least in part on a timing advance (TA) accuracy associated with the UE; and
transmitting, via a resource in the resource pool, an uplink transmission in accordance with a UE uplink self-scheduling.

19. The method of claim 18, wherein the resource pool, of the plurality of resource pools, is associated with one or more characteristics, and the one or more characteristics are related to one or more of: a guard band, an allocation of multiple-user multiple-input multiple-output (MU-MIMO) resources, a modulation and coding scheme (MCS), a power limit, a demodulation reference signal (DMRS) density, or a phase tracking reference signal (PTRS) density.

20. The method of claim 19, wherein selecting the resource pool is based at least in part on the one or more characteristics associated with the resource pool.

21. The method of claim 18, further comprising:
receiving signaling that contains one or more instructions for estimating the TA accuracy based at least in part on one of: a time difference between TAs, a measurement difference between reference signals, or a Doppler shift difference between the reference signals; and
estimating the TA accuracy based at least in part on the signaling.

22. The method of claim 21, wherein the signaling indicates a list of time difference ranges, measurement difference ranges, or Doppler shift difference ranges, and each range is mapped to a corresponding TA accuracy.

23. The method of claim 18, wherein the configuration indicates a list of TA accuracy ranges, wherein each TA accuracy range in the list is mapped to a corresponding resource pool of the plurality of resource pools, and the corresponding resource pool is associated with one or more characteristics that serve to limit interference based at least in part on the TA accuracy range.

24. The method of claim 18, further comprising:
receiving, via downlink control information (DCI), an update to the configuration.

25. The method of claim 18, further comprising:
initiating a random access procedure to acquire a new TA when the TA accuracy satisfies a defined threshold.

26. The method of claim 18, further comprising:
initiating, after a defined number of unsuccessful retransmissions of the uplink transmission, a random access procedure to obtain a new TA.

27. The method of claim 18, further comprising:
falling back to a different resource pool, of the plurality of resource pools, for the uplink transmission based at least in part on a lack of acknowledgement for the uplink transmission.

28. A method of wireless communication performed at a network node, comprising:
transmitting a configuration that indicates a plurality of resource pools; and
receiving, via a resource in a resource pool of the plurality of resource pools, an uplink transmission, wherein the resource pool is associated with a timing advance (TA) accuracy of a user equipment (UE).

29. The method of claim 28, wherein the resource pool, of the plurality of resource pools, is associated with one or more characteristics, and the one or more characteristics are related to one or more of: a guard band, an allocation of multiple-user multiple-input multiple-output (MU-MIMO) resources, a modulation and coding scheme (MCS), a power limit, a demodulation reference signal (DMRS) density, or a phase tracking reference signal (PTRS) density.

30. The method of claim 28, further comprising:
transmitting signaling that contains one or more instructions for estimating the TA accuracy based at least in part on one of: a time difference between TAs, a measurement difference between reference signals, or a Doppler shift difference between the reference signals, wherein the signaling indicates a list of time difference ranges, measurement difference ranges, or Doppler shift difference ranges, and each range is mapped to a corresponding TA accuracy.
